(19) United States
(12) Patent Application Publication
(10) Pub. No.: US 2003/0028596 A1
(43) Pub. Date: Feb. 6, 2003

(54) Community-based collaborative knowledge system, and user access limiting method in that system

(75) Inventors: Mayo Toyota, Ome-shi (JP); Hitoshi Tanigawa, Higashiyamato-shi (JP); Masaaki Iwata, Ome-shi (JP); Kazunori Shimakawa, Ome-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI TOSHIBA

(21) Appl. No.: 10/084,308

(22) Filed: Feb. 28, 2002

(30) Foreign Application Priority Data
May 15, 2001 (JP) 2001-145250

(51) Int. Cl. G06F 15/16

(52) U.S. Cl. 709/204

(57) ABSTRACT

A community server categorizes and accumulates messages exchanged by users on a virtual community for respective topics. The community server includes a user access limiting control unit. The user access limiting control unit determines user's access authority of each client terminal for each community as an access destination. For this purpose, the user access limiting control unit manages a community type indicating the open level of each community, and a member type indicating the participation attribute of each user to the virtual community, using community management information, and limits access to a community as an access destination for each client terminal on the basis of the combination of the community type and member type.

### CROSS-REFERENCE TO RELATED APPLICATIONS

This application is based upon and claims the benefit of priority from the prior Japanese Patent Application No. 2001-145250, filed May 15, 2001, the entire contents of which are incorporated herein by reference.

### BACKGROUND OF THE INVENTION

1. Field of the Invention

The present invention relates to a community-based collaborative knowledge system used in a knowledge management system, and a user access limiting method in that system and, more particularly, to a community-based collaborative knowledge system that supports knowledge accumulation using a virtual community in which many unspecified users participate, and a user access limiting method in that system.

2. Description of the Related Art

In recent years, an increasing number of enterprises are introducing groupware which can be used to share information among a plurality of users. As typical groupware, an e-mail system, workflow system, and the like are known. Recently, a knowledge management system used to support knowledge and information sharing is beginning to be developed.

The knowledge management system accumulates and manages individual know-how as a knowledge database in addition to Web information and digital file information. This system allows to efficiently use knowledge and information when it is combined with a search function (e.g., natural language search).

For such knowledge management system, how to collect and accumulate knowledge such as individual know-how is an important issue. Since knowledge such as individual know-how is so-called tacit knowledge, and does not have any predetermined format unlike Web information and digital file information, it is difficult to automatically collect and accumulate such knowledge.

Hence, the development of a knowledge management system having a community-based collaborative knowledge function is required recently. By implementing a mechanism for automatically collecting and accumulating knowledge such as individual know-how, tacit knowledge can be exploited like explicit knowledge such as Web information and digital file information.

However, to accumulate knowledge, a site where many users actively exchange their opinions must be prepared, and a mechanism for making users spontaneously participate in such site is required.

In this case, participation of users is not expected depending on the type of opinion exchange site unless security is considered. Conversely, a site where users can freely participate without any specific participation procedure is necessary. If such site is not managed appropriately, the number of users who spontaneously participate decreases even when such opinion exchange site is prepared, and finally, the presence of such site itself becomes insignificant.

### BRIEF SUMMARY OF THE INVENTION

It is an object of the present invention to provide a community-based collaborative knowledge system which can automatically and efficiently collect and accumulate knowledge such as individual know-how, using a virtual community as an opinion exchange site in consideration of security and openness, and a user access control method in that system.

In order to achieve the above object, according to the present invention, there is provided a community-based collaborative knowledge system which can be connected to a plurality of client terminals via a network, and supports knowledge accumulation by categorizing and accumulating messages posted front each client terminal to a virtual community, comprising access control means for making user authentication of a client terminal as an access request source so as to permit the client terminal to post a message, and community processing means for managing a virtual community in which a plurality of client terminals can participate, and categorizing and accumulating messages posted, to the virtual community, from the client terminals, which are granted access permission by the access control means, for respective topics, the community processing means including user access limiting means for managing a community type indicating an open level of each virtual community, and a member type indicating a participation attribute of a user to the virtual community, and determining user's access authority of each client terminal using a combination of the community type and member type for each virtual community as an access destination.

In this community-based collaborative knowledge system, messages exchanged by users on a virtual community are categorized and accumulated for respective topics, thus automatically collecting individual knowledge contained in discussion made among a plurality of users. Especially, since a mechanism for managing a community type indicating the open level of a virtual community, and member types indicating participation attributes of users to that virtual community for each individual virtual community, and determining the access authority of each client terminal user by a combination of the community type and member type for each virtual community as an access destination of that user, accesses that each user can make can be automatically limited. Therefore, management for limiting browsing or the like of messages on a virtual community to only specific members or opening to many unspecified users can be made for each individual virtual community as needed, and knowledge sharing can be achieved while maintaining desired security level. Since the user himself or herself need not manage information associated with communities and member types even when the number of communities he or she participates in increases, spontaneous participation will to communities can be prevented from declining due to complicated operations and the like.

Since accesses that a client terminal as an access request source is allowed to make are determined, and a window on which these accesses can be made is provided to that client terminal as an access request source, the user himself or herself can use a virtual community without being troubled about the participation attribute of each virtual community. Since only allowed accesses are displayed on the window, the user can be prevented from recognizing that he or she has made a certain access on the window, to which he or she is not entitled, only after he or she has made that access and the access has been denied.

Also, since means for managing summary messages that summarize messages for respective topics in addition to normal messages is provided, summary messages having an open attribute can have an access limitation different from other messages. Hence, only conclusions that can be open to the public can be provided as open summary messages to many unspecified users while maintaining secrecy of individual messages.

Search means that searches messages accumulated in respective virtual communities in response to a search request from each client terminal is provided, and a mechanism which provides to a client terminal as a search request source only a search result list associated with messages that the client terminal as the search request source can browse from those which match the search request on the basis of the combination of the community type of a virtual community which is to undergo a search, and the member type of the client terminal as the search request source is preferably used.

With this mechanism, since the user can be prevented from being denied browsing actual data of a given message since he or she does not have any authority to browse it upon selecting the message contained in the search result list, desired access limitations can be realized without failing the user's participation will to communities.

As described above, according to the present invention, knowledge such as individual know-how and the like can be efficiently collected and accumulated by effectively using a virtual community as an opinion exchange site, and various kinds of knowledge can be shared.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the system arrangement of a community-based collaborative knowledge system according to an embodiment of the present invention;

FIG. 2 is a view for explaining knowledge processed by the community-based collaborative knowledge system of this embodiment;

FIG. 3 is a view for explaining knowledge accumulation process in the community-based collaborative knowledge system of this embodiment;

FIG. 4 is a view for explaining the relationship between messages and threads managed by the community-based collaborative knowledge system of this embodiment;

FIG. 5 is a view for explaining the relationship between messages and “summary” messages managed by the community-based collaborative knowledge system of this embodiment;

FIG. 6 shows an example of a user table used in the community-based collaborative knowledge system of this embodiment;

FIG. 7 shows an example of a community table used in the community-based collaborative knowledge system of this embodiment;

FIG. 8 shows an example of a subscription type table used in the community-based collaborative knowledge system of this embodiment;

FIG. 9 shows an example of a member table used in the community-based collaborative knowledge system of this embodiment;

FIG. 10 shows an example of a thread table used in the community-based collaborative knowledge system of this embodiment;

FIG. 11 shows an example of a message table used in the community-based collaborative knowledge system of this embodiment;

FIG. 12 shows an example of a summary table used in the community-based collaborative knowledge system of this embodiment;

FIG. 13 shows an example of the relationship among communities, members, and users, managed by the community-based collaborative knowledge system of this embodiment;

FIG. 14 is a view for explaining an example of a user permitted access table used in the community-based collaborative knowledge system of this embodiment;

FIG. 15 is a view for explaining the types of summary messages managed in a membership community of the community-based collaborative knowledge system of this embodiment;

FIG. 16 is a flow chart showing the sequence of a user access limiting process in the community-based collaborative knowledge system of this embodiment;

FIGS. 17A to 17C show an example of a community list window provided to the user by the community-based collaborative knowledge system of this embodiment;

FIG. 18 shows an example of an access window provided to the user by the community-based collaborative knowledge system of this embodiment;

FIG. 19 shows an example of a my page window provided to the user by the community-based collaborative knowledge system of this embodiment;

FIG. 20 is a flow chart showing some steps of the sequence of a message search process in the community-based collaborative knowledge system of this embodiment; and

FIG. 21 is a flow chart showing the remaining steps of the sequence of the message search process in the community-based collaborative knowledge system of this embodiment.

### DETAILED DESCRIPTION OF THE INVENTION

A preferred embodiment of the present invention will be described hereinafter with reference to the accompanying drawings.

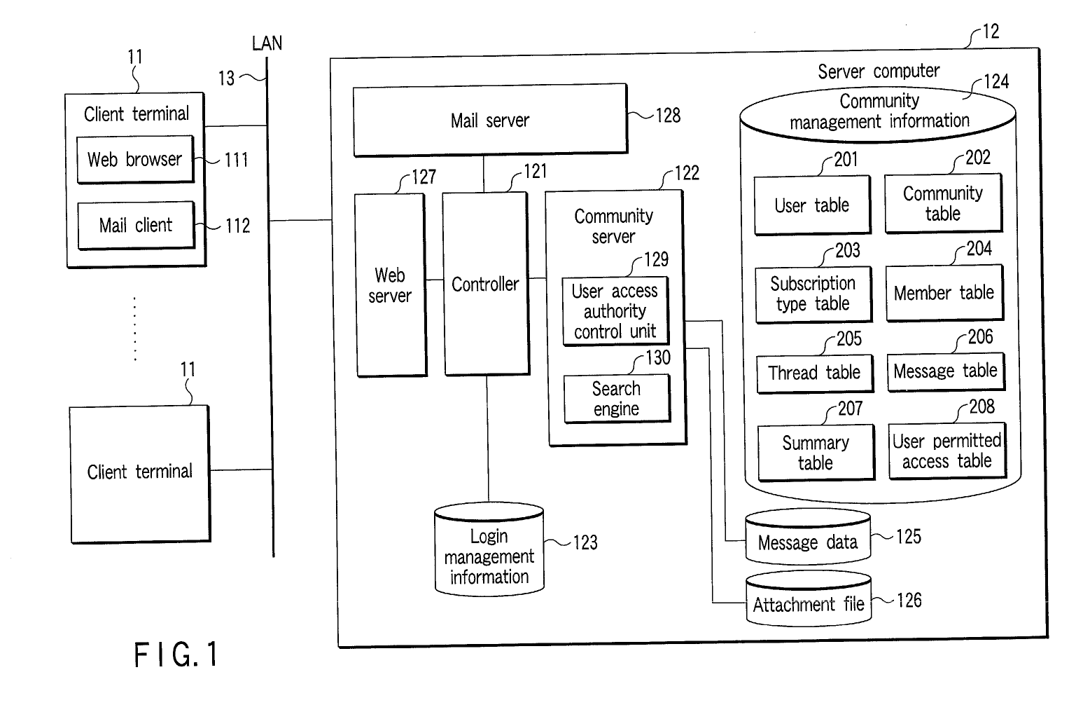

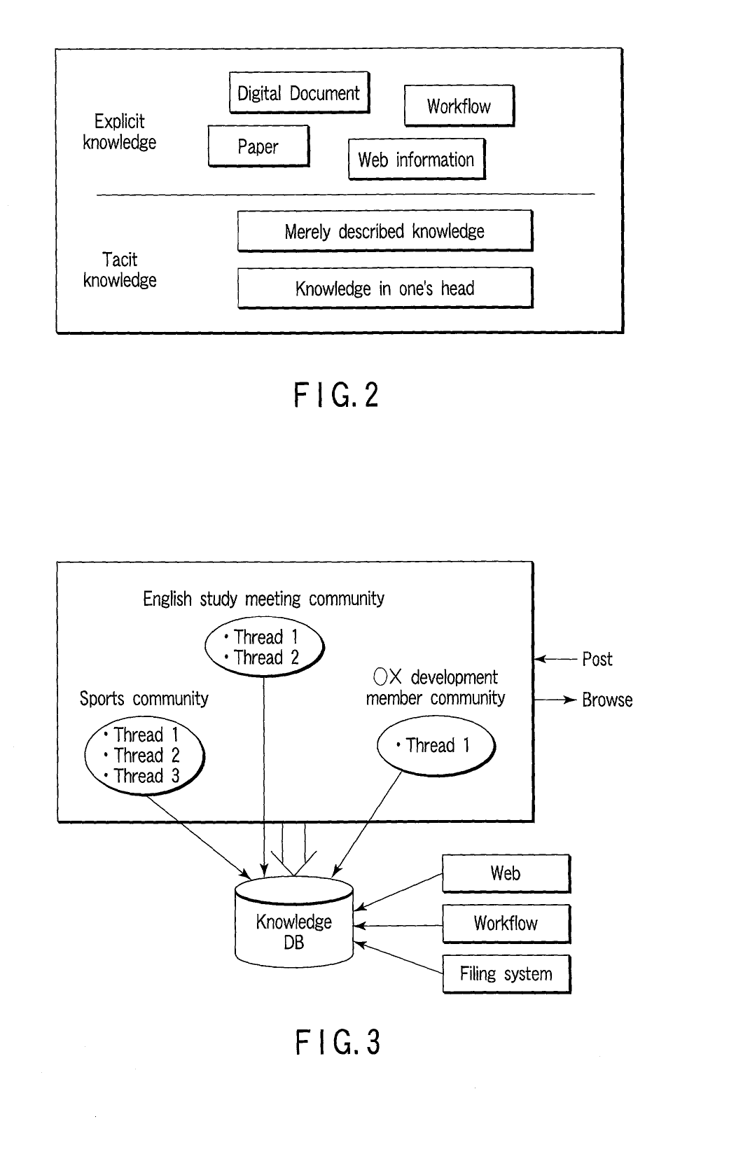

FIG. 1 shows the arrangement of a community-based collaborative knowledge system according to an embodiment of the present invention. This community-based collaborative knowledge system is used as a knowledge management system having a community-based collaborative knowledge function, and categorizes and accumulates knowledge using a virtual community to which a plurality of client terminals 11 can commonly access. Prior to a detailed description of the arrangement, an outline of the community-based collaborative knowledge system according to this embodiment will be explained first using FIGS. 2 to 5.

As shown in FIG. 2, there are two kinds of knowledge, i.e., “explicit knowledge” and “tacit knowledge”. Nowadays, arrangement and management systems such as a document management system, Web server, and the like for explicit information (explicit knowledge) have nearly reached a point of maturity. However, in practice, these systems cannot support all aspects of “accumulation of knowledge”. This is because there exists very indefinitive information such as casual conversation exchanged via mail messages, knowledge only in one's head, and the like. Such information is called “tacit knowledge”. How to process and share such tacit knowledge is an important issue. It is difficult for a conventional system to support accumulation of tacit knowledge, and a system that can process tacit knowledge is required.

A community-based collaborative knowledge system of this embodiment is a tool which converts such information called tacit knowledge into explicit knowledge, and aims at promoting knowledge accumulation, allows discussions in a group in a virtual community having an electronic bulletin board format, and categorizes and accumulates messages (posted articles) for respective topics. Also, this system can generate a summary of one topic (to be referred to as a thread hereinafter). The thread means a bundle of given related knowledge on the virtual community. The summary is a message having a role of a kind of proceeding that summarizes the discussions in the group, and can be generated for each individual thread.

A message is posted via an e-mail message or by input from a Web browser, and posted messages are saved in a server which forms the community-based collaborative knowledge system. In this community-based collaborative knowledge system, a message can also be posted using an e-mail message, and has a function as a mailing list. When respective users communicate with each other via mail messages, tacit knowledge is accumulated unconsciously. FIG. 3 shows this state.

FIG. 3 shows “sports community” as a virtual community associated with sports, “English study meeting community” as a virtual community associated with an English study meeting, and “◯X development member community” as a virtual community of given development members. Messages posted by respective users are categorized and accumulated for these virtual communities, and are categorized for respective threads in each virtual community. FIG. 3 shows a case wherein messages associated with three different topics, i.e., threads 1, 2, and 3 are currently accumulated in “sports community”, messages associated with two different topics, i.e., threads 1 and 2 are accumulated in “English study meeting community”, and messages associated with one topic, i.e., thread 1 are accumulated in “◯X development member community”. Messages posted to these virtual communities are accumulated as knowledge information in a knowledge database (knowledge DB) as well as other kinds of knowledge (explicit knowledge collected from Webs, workflow, filing systems, and the like). Especially, when “summary” messages generated for respective threads are collected in the knowledge DB and are applied to full-text search, natural language search, and the like prior to other messages, the “flow of messages” as so-called flow information can be efficiently utilized as static stock information.

<Site>

In this specification, the server function of this community-based collaborative knowledge system is called a “site”. An administrator is present in the site, and manages site information. The site information includes:

(1) User Information

This information is associated with users who can use the site.

The site administrator can register, delete, and change this information.

(2) Community Creation Authority Information

This information is authority information required upon creating a virtual community.

A virtual community is a kind of electronic bulletin board to which a plurality of users can commonly access to post and browse messages, and indicates a “site” where people who have the same objective communicate with each other. Each user accesses a community with a theme corresponding to his or her objective, and acquires desired knowledge or posts a message (article). Each community has at least one administrator (a community creator becomes a default administrator but this can be changed). The authority associated with creation of a community can be selected from the following two choices.

All the registered users can create a community.

Only the user who is authorized by the site administrator can create a community.

(3) Category Information of Community

This information is category information used to categorize communities.

The site administrator can register, delete, and change this information.

<Community>

A community will be explained below. Community information (property of a community) used to manage each community includes:

(1) Name

This indicates the name of community.

(2) Posting Mail Address

This address is a mail address assigned to each community. When the user sends a mail message to this address, its contents are automatically registered in the corresponding community as a new message.

(3) Subject Information of Received Mail

The user can participate in a community in two ways; either he or she can “subscribe via Web” or browse and post messages via a Web browser, or he or she can “subscribe via mail” or receive an automatic mail delivery service of new messages in addition to browsing and posting of messages via the Web browser. For a user who selected “subscribe via mail”, when a new message is posted to a given community, that new message is automatically delivered as an e-mail message. In this case, Subject information of the delivered e-mail message is appended with “Subject information of received mail” (e.g., information such as {community name, message number}).

(4) Creator

This indicates the user name of the user who created a community.

(5) Date of Creation

This indicates the date of creation of a community.

(6) Introduction of Community

This indicates a simple introduction of a community.

(7) Category of Community

As described above, communities can be categorized according to their contents, and information associated with a category is held for each community. The category is registered by the site administrator.

(8) Community Type

The community type means the open level of a community. The open levels of communities include “open” that allows everyone to participate, “membership” for only a group of authorized members, and “closed” that is not open to the public other than authorized members.

(9) Statistic Information

This information includes the number of users who belong to each community, posting count ranking for respective members, and the like.

(10) Administrator

This indicates the name of an administrator who manages a given community.

(11) Member

This indicates users who belong to (can access) a given community.

(12) Message Delete Authority

This indicates a user who is authorized to delete a posted message. There are two choices:

community administrator alone

community administrator and poster

<Message and Thread>

A message and thread will be described below.

A message is each of comments (posted articles) exchanged in discussion in a community. The message can be appended with a plurality of files. The message can be posted by input from a Web browser or by sending a mail message to the mail address of a given community.

On the other hand, a thread is a bundle of messages associated with a given topic. Discussion progresses via various opinions (messages) for one topic and reaches a conclusion. This conclusion is a “summary”. This community-based collaborative knowledge system also has a creation support function associated with “summary”. Using this creation support function, a “summary” as a conclusion of a given topic can be easily created while quoting messages, appended files, and the like in the corresponding thread.

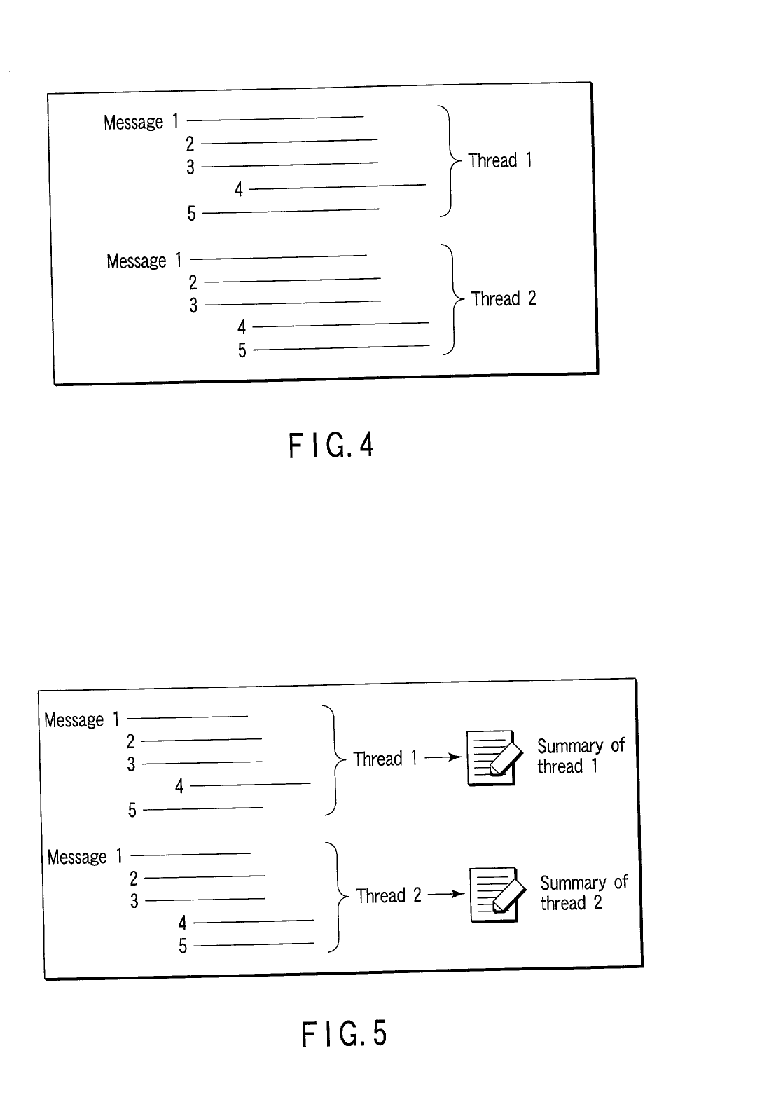

FIG. 4 shows an example of the hierarchical structure of messages which form a thread. Referring to FIG. 4, thread 1 contains five messages 1, 2, 3, 4, and 5. The structure of thread 1 corresponds to a case wherein message 1 was posted first, messages 2 and 3 were posted as reply (response) messages to message 1, message 4 was posted as a reply (response) message to message 3, and message 5 was further posted as a reply (response) message to message 1.

Thread 2 also contains five messages 1, 2, 3, 4, and 5. The structure of thread 2 corresponds to a case wherein messages 2 and 3 were posted as reply (response) messages to message 1 which was posted first, and messages 4 and 5 were posted as reply (response) messages to message 3.

When a message different from a reply to each message of threads 1 and 2 is newly posted to the same community as threads 1 and 2, thread 3 is assigned to that new message.

<Summary>

A “summary” is “conclusion” of discussion (thread). In other words, the “summary” corresponds to “proceeding” in, e.g., a business meeting, or corresponds to “specification” for review upon development. As shown in FIG. 5, one “summary” corresponds to one thread. That is, the user or administrator creates a “summary” as a conclusion for each thread, and manages it as one special form of messages which form the corresponding thread. The “summary” can be appended with a plurality of files as in normal messages.

The “summary” can be revised, and a new “summary” is created by, e.g., updating the already created “summary” and can be registered as the latest “summary”.

<Message Posting by Mail>

A message posted to each community via a mail message is processed in the following sequence.

(1) A user posts a mail message to a mail address assigned to a community as a destination.

(2) The server of the community-based collaborative knowledge system simultaneously acquires mail messages to all communities from a mail server.

(3) The server of the community-based collaborative knowledge system checks the destinations of the messages based on their posting mail addresses and distributes them.

(4) The server of the community-based collaborative knowledge system determines a thread and layer of the corresponding community to which the message of interest is to be registered on the basis of header information (or title) of the acquired mail message, and registers text of the acquired mail message thereto as a message.

A message posted to each community as a mail message is automatically stored in the corresponding location by the aforementioned process. The user need only post a message as if he or she were posting a comment to a mailing list.

<Message Subscription Type>

A user who uses the community-based collaborative knowledge system can select one of two choices as the message subscription type, as described above.

subscribe via Web browser (the user accesses the URL (Uniform Resource Locator) of the community-based collaborative knowledge system)

subscribe via mail

The user can subscribe (can also post a message) via a Web browser independently of the subscription type of his or her choice. That is, the user can select whether or not a new message is automatically delivered to him or her when it is posted. If the user selects mail subscription, a message is delivered as a mail message. The user can select the subscription type for each community he or she belongs.

<System Arrangement>

The system arrangement of the community-based collaborative knowledge system according to this embodiment will be described below with reference to FIG. 1.

The community-based collaborative knowledge system of this embodiment is implemented by a server computer 12 which can be connected to a plurality of client terminals 11 via a computer network 13 such as a LAN or the like. Each of the server computer 12 and client terminals 11 has a CPU, a main memory, a magnetic disk device as a storage device, and input/output devices including an input unit such as a keyboard, mouse, and the like, and a display unit such as a display (none of them are shown).

On each client terminal 11, one or both of a Web browser 111 and mail client 112 run. Each user can use a community-based collaborative knowledge process from each client terminal 11 by designating the URL (Uniform Resource Locator) indicating the resource for the community-based collaborative knowledge system built on the server computer 12 from the Web browser 111 or sending a mail message from the mail client 112 to a mail address of each community managed by a community server 112.

The community-based collaborative knowledge function on the server computer 12 is implemented mainly by software programs of a controller 121, the community server 122, a Web server 127, a mail server 128, and the like, and management information and actual data used to post and browse messages by these software programs. The management information includes login management information (user ID+password) 123 used to authenticate the user of each client terminal 11, and community management information 124 used to manage each community. Also, the actual data include message data 125 and attachment files 126.

The controller 121 controls the overall operations associated with the community-based collaborative knowledge function, and has a mediation function between the Web server 127 and mail server 128, and the community server 122 as a core program of this community-based collaborative knowledge system, and also a user authentication function when each client terminal 11 logs into the community server 122 via the Web server 127 and mail server 128. For user authentication, the controller 121 manages the login management information 123. The login management information stores the user IDs, passwords, and the like of individual users who participate in the community-based collaborative knowledge system. With this user authentication, access from each client terminal 11 to the community server 122, which is made to, e.g., post a message, undergoes permission/denial control.

The community server 122 manages and runs communities in which a plurality of client terminals 11 can participate, and categorizes and accumulates messages posted by respective client terminals 11 for respective communities and topics (threads). The community server 122 manages and runs communities using the community management information 124, message data, and attachment files 126. That is, these community management information 124, message data, and attachment files 126 are used as a database for accumulating and manages messages for respective communities.

Furthermore, the community server 122 includes a user access authority control unit 129 and search engine 130. The user access authority control unit 129 determines the access authority of the user of each client terminal 11 for each community as the access destination of the user. For this purpose, the user access authority control unit 129 manages community types indicating the open levels of communities, and member types indicating participation attributes of users with respect to a given virtual community using the community management information 124, and limits accesses to a community as an access destination for each client terminal 11 by the combination of the community type and member type. Details of the limiting method will be described later. Basically, accesses that a client terminal 11 as an access request source can make are determined, and a window on which only these assesses are allowed is provided to the client terminal as the access request source.

The search engine 130 searches messages of respective communities accumulated as the message data 125 for desired messages by full-text search or natural language search. When a list of messages found by the search engine 130 is sent to a client terminal 11 as a search request source, a search result list of only messages that the browsing authority of the client terminal 11 as the search request source can cover is sent to the client terminal 11 as the search request source under the control of the user access authority control unit 129.

Tables which form the community management information 124 will be explained below.

As shown in FIG. 1, the community management information 124 is formed of a user table 201, community table 202, subscription type table 203, member table 204, thread table 205, message table 206, summary table 207, user permitted access table 208, and the like. These tables will be explained below.

<User Table>

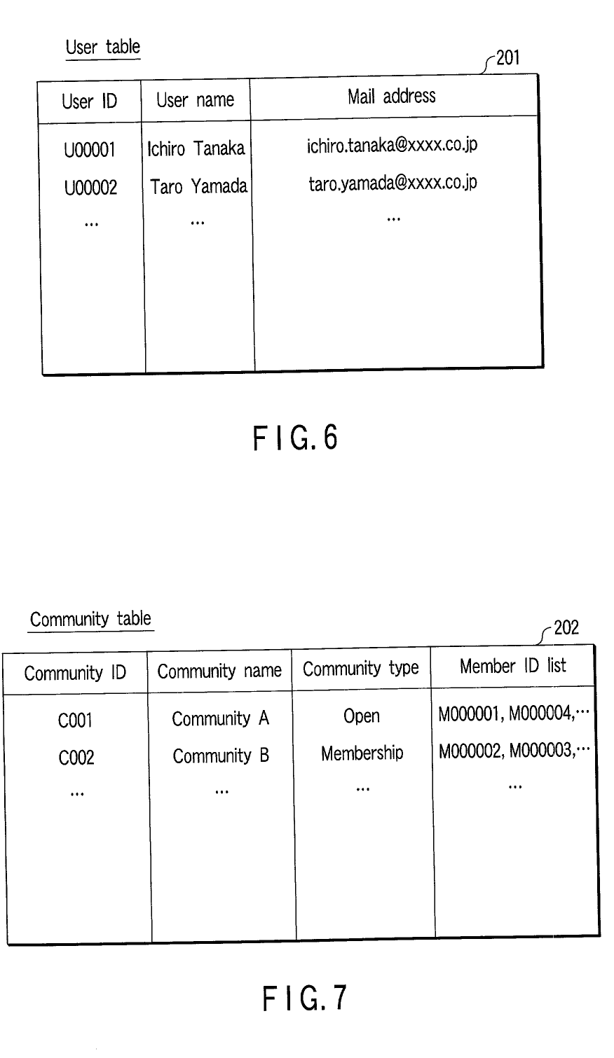

FIG. 6 shows an example of the structure of the user table 201 that manages the users. The user table 201 stores the user IDs, user names, and mail addresses of users who participate in this system. FIG. 6 exemplifies a case wherein a user who has the user ID “U00001”, user name “Ichiro Tanaka”, and mail address “ichiro.tanaka@xxxx.co.jp”, and a user who has the user ID “U00002”, user name “Taro Yamada”, and mail address “taro.yamada@xxxx.co.jp” are registered.

<Community Table>

FIG. 7 shows an example of the structure of the community table 202 used to manage communities. The community table 202 is used to manage information that pertains to communities created on the community-based collaborative knowledge system of this embodiment, and stores the community IDs, community names, and community types of communities created on this community-based collaborative knowledge system, and the member ID lists of members who participate in these communities in correspondence with each other. FIG. 7 shows a case wherein a community with the community ID “C001” and community name “community A” has the community type “open”, and users who are assigned the member IDs “M0001”, “M000004”, . . . participate in this community; and a community with the community ID “C002” and community name “community B” has the community type “membership”, and members who are assigned the member IDs “M000002”, “M000003”, . . . participate in this community. Note that the member IDs are unique throughout the communities, and each user is assigned member IDs, the number of which is equal to the number of communities he or she participates in.

<Subscription Type Table>

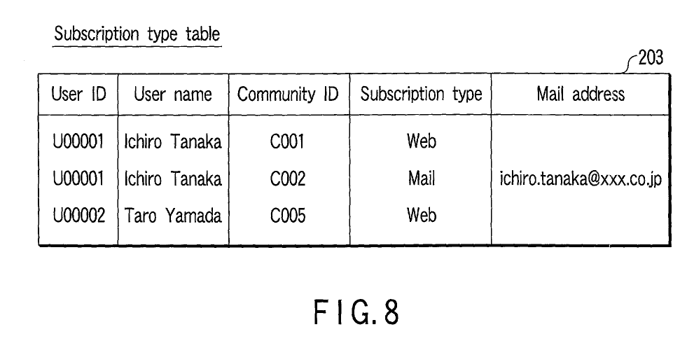

FIG. 8 shows an example of the structure of the subscription type table 203 used to manage the subscription types. The subscription type table 203 stores the user IDs and user names of users who participate in this system, the community IDs of communities they participate in, subscription types to these communities, and users' mail addresses if the subscription type is “mail”. When the user table 201 manages the mail addresses, the mail addresses need not always be registered in the subscription type table 203. Conversely, the user table 201 may not manage any mail addresses, and the subscription type table 203 may manage mail addresses of only users who selected the subscription type “mail”.

FIG. 8 shows a case wherein the user who has the user ID “U00001” and user name “Ichiro Tanaka” participates in two communities with the community IDs “C001” and “C002”, and selects the subscription type “Web” for the community with the community ID “C001” and the subscription type “mail” for the community with the community ID “C002”; and the user who has the user ID “U00002” and user name “Taro Yamada” participates in a community with the community ID “C005”, and selects the subscription type “Web” for that community.

<Member Table>

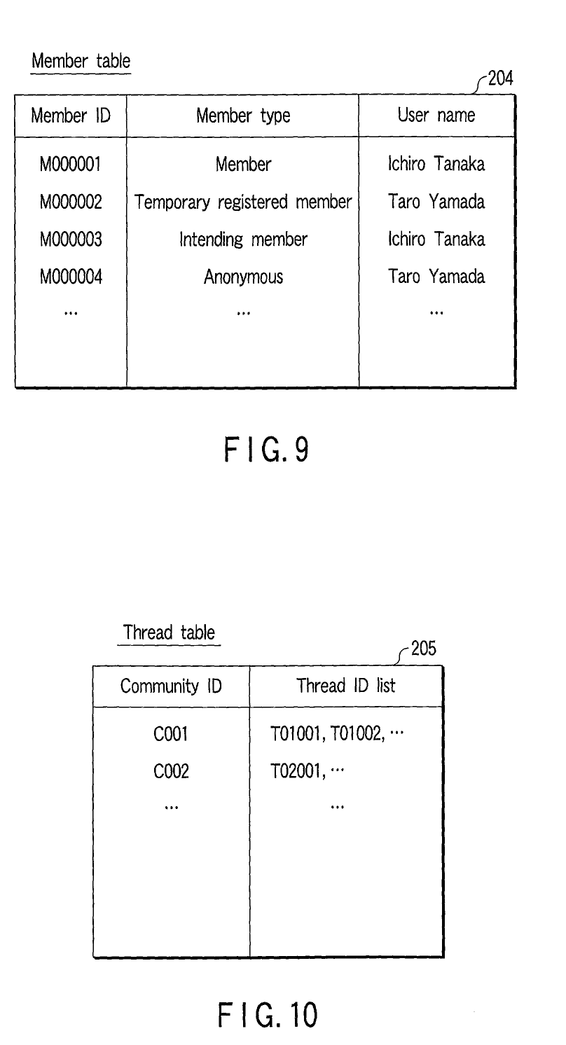

FIG. 9 shows an example of the structure of the member table 204 used to manage members. The member table 204 stores member types indicating participation attributes associated with communities they participate in, and the user names of users who participate as members. The member types include “member” who has been authorized to participate, “temporary registered member” who is temporarily registered as a member, “intending member” who has applied to participate but has not been authorized to participate yet, and “anonymous member” who does not take any participation procedure and participates in a community as a kind of guest.

FIG. 9 shows a case wherein the user who has the user name “Ichiro Tanaka” has the member type “member” for a community in which he participates with the member ID “M000001”, and the member type “intending member” for a community in which he participates with the member ID “M000003”; and the user who has the user name “Taro Yamada” has the member type “temporary registered member” for a community in which he participates with the member ID “M000002”, and the member type “anonymous member” for a community in which he participates with the member ID “M000004”.

<Thread Table>

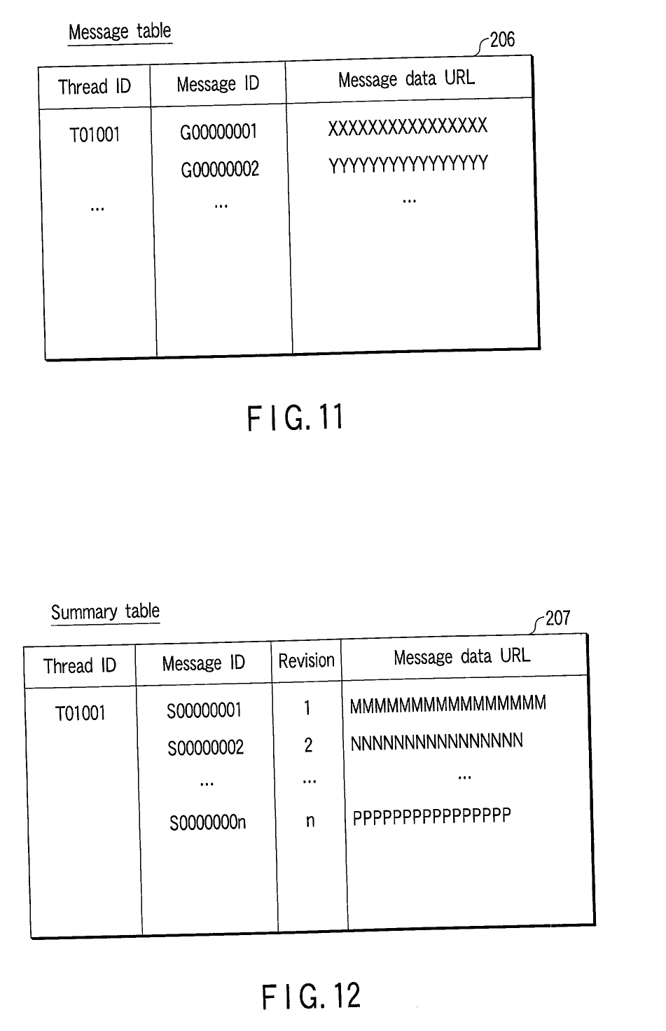

FIG. 10 shows an example of the structure of the thread table 205 used to manage threads. The thread table 205 stores the community IDs of communities, and thread ID lists each including the thread IDs of threads generated in a given community. The thread IDs use unique values throughout the communities.

FIG. 10 shows a case wherein a community with the community ID “C001” includes threads with thread IDs “T01001”, “T01002”, . . . ; and a community with the community ID “C002” includes threads with thread IDs “T02001”, . . .

<Message Table>

FIG. 11 shows an example of the structure of the message table 206 used to manage messages. The message tables 206 stores the message IDs of messages which form each individual thread, and the URL information (message data URLS) indicating the locations of actual data of corresponding messages stored as the message data 125. Note that this message data URL may be uniquely specified by the corresponding thread ID and message ID and, in such case, the message data URL field may be omitted.

<Summary Table>

FIG. 12 shows an example of the structure of the summary table 207 used to manage “summary” messages created for respective threads. The summary table 207 stores the message IDs of messages created and registered as “summary” messages of a given thread, the revision numbers of messages when a plurality of “summary” messages are created and registered, and URL information (message data URLs) indicating the locations of actual data of messages associated with the corresponding “summary” messages stored as the message data 125 in correspondence with each thread ID.

As in the message table 206, the message data URL of the summary table 207 may be uniquely specified by the corresponding thread ID and message ID and, in such case, the message data URL field may be omitted.

<User Permitted Access Table>

The user permitted access table 208 will be described below.

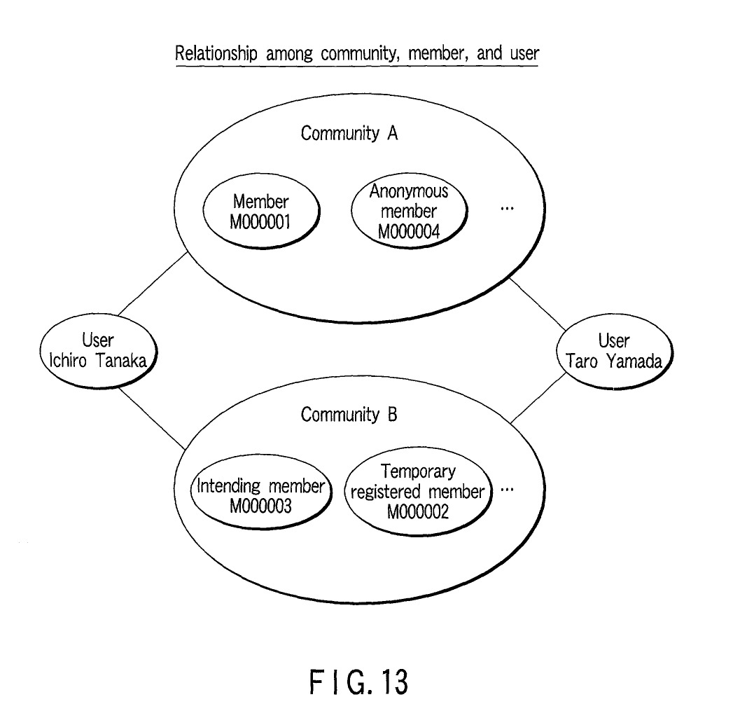

Prior to the description of the structure of the user permitted access table 208, the relationship among communities, members, and users will be explained below. FIG. 13 shows an example of the relationship among communities, members, and users.

FIG. 13 assumes a case wherein member M000001 and anonymous member M000004 are present in community A, and intending member M000003 and temporary registered member M000002 are present in community B. The user with the user name “Ichiro Tanaka” is member M000001 of community A, and intending member M000003 of community B, and the user with the user name “Taro Yamada” is anonymous member M000004 of community A and temporary registered member M000002 of community B.

In this way, each user can participate in a plurality of communities, and the member type is individually set for each community he or she participates in.

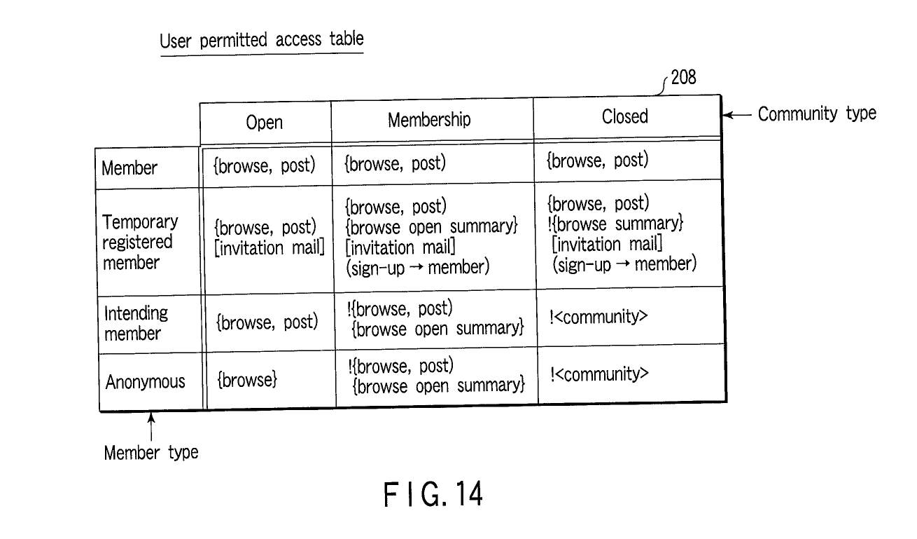

FIG. 14 shows an example of the structure of the user permitted access table 208. The user permitted access table 208 is made up of a matrix of three different community types “open”, “membership”, and “closed”, and four different member types “member”, “temporary registered member”, “intending member”, and “anonymous member”. Permitted accesses and actions are defined in advance depending on combinations of these three community types and four member types.

For example, if “×” represents a combination, the following expressions and meanings are obtained. Note that “!” in FIG. 14 indicates NOT.

(1) “open”×“member”={browse, post}

This means that a combination of “open” and “member” allows to browse and post in that community.

(2) “open”×“temporary registered member”={browse, post}, [invitation mail]

This means that a combination of “open” and “temporary registered member” allows to browse and post in that community, and also means that an “invitation mail message is delivered” from the community server 122 to “temporary registered members”. With the invitation mail message, the administrator of a given community invites the user who is set as “temporary registered member” to participate in the corresponding community as “member”. The invitation mail message that contains an introduction of that community, link information (URL) to a sign-up window, and the like is automatically sent to all users who are set as “temporary registered members”.

(3) “open”×“intending member”={browse, post}

This means that a combination of “open” and “intending member” allows to browse and post in that community.

(4) “open”×“anonymous member”={browse}

This means that a combination of “open” and “anonymous member” allows to only browse in that community.

(5) “membership”×“member”={browse, post}

This means that a combination of “membership” and “member” allows to browse and post in that community.

(6) “membership”×“temporary registered member”={browse, post}, {browse open summary}, [invitation mail], (sign-up→member)

This means that a combination of “membership” and “temporary registered member” allows to browse and post in that community. However, upon browsing “summary” messages, that user can browse only “summary” messages with attribute “open summary”. Furthermore, an “invitation mail message is delivered” from the community server 122 to “temporary registered members”, and for the user who proceeds to sign up on the sign-up procedure window, the member type is changed from “temporary registered member” to “member”.

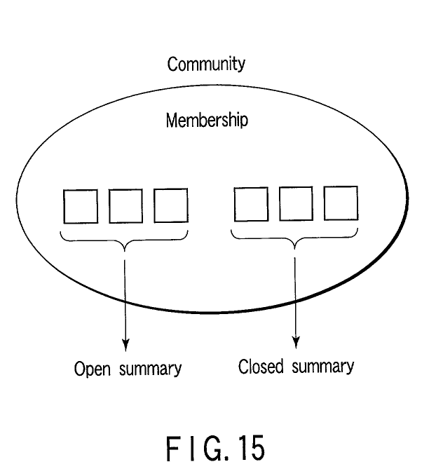

In “open” and “closed” communities, “summary” messages are handled in the same manner as other normal messages. However, in “membership” communities, “summary” messages can be set as either “open summary” which are open to non-members other than “members”, or “closed summary” which are not open to non-members other than “members”, as shown in FIG. 15.

(7) “membership”×“intending member”=!{browse, post}, {browse open summary}

This means a combination of “membership” and “intending member” allows to neither browse nor post normal messages, and allows to browse only “summary” messages set with attribute “open summary”.

(8) “membership”×“anonymous member”=!{browse, post}, {browse open summary}

This means a combination of “membership” and “anonymous member” allows to neither browse nor post normal messages, and allows to browse only “summary” messages set with attribute “open summary”.

(9) “closed”×“member”={browse, post}

This means that a combination of “closed” and “member” allows to browse and post in that community.

(10) “closed”×“temporary registered member”=!{browse, post}, !{browse open summary}, [invitation mail], (sign-up→member)

This means a combination of “closed” and “temporary registered member” allows to neither browse nor post in that community. Also, “summary” messages cannot be browsed since such community has no attribute “open summary”. Furthermore, an “invitation mail message is delivered” from the community server 122 to “temporary registered members”, and for the user who proceeds to sign up on the sign-up procedure window, the member type is changed from “temporary registered member” to “member”.

(11) “closed”×“intending member”=!<community>

This means that a combination of “closed”×“intending member” is impossible since such user does not know even the presence of that community.

(12) “closed”×“anonymous member”=<community>

This means that a combination of “closed”×“anonymous member” is impossible since such user does not know even the presence of that community.

<User Access Limiting Process #1>

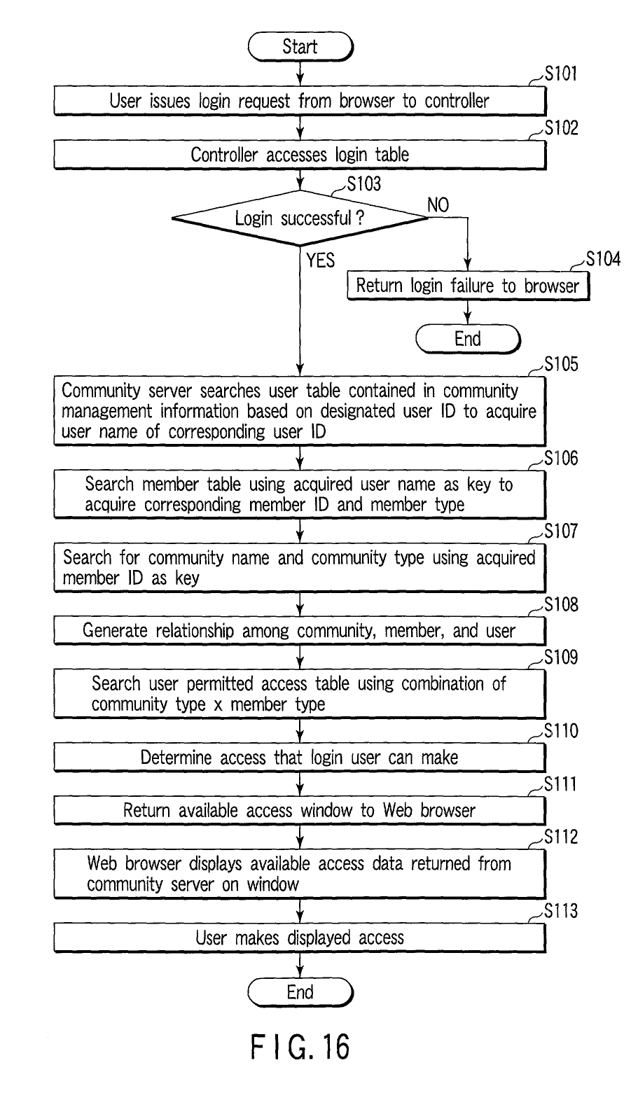

The sequence for automatically limiting accesses to a community as an access destination for each client terminal 11 by a combination of the community type and member type will be explained below with reference to the flow chart in FIG. 16.

The Web browser 111 issues a login request to the controller 121 of the server computer 12 via the Web server 127 in response to user's operation on the Web browser 111 (step S101). The controller 121 accesses the login management information 123 (step S102) to check if the user ID and password input from that user are registered, and makes user authentication (step S103) to determine if that login access is permitted.

If the user ID and password are not registered in the login management information 123 and the login access has failed (NO in step S103), the controller 121 returns a login failure to the Web browser 111 via the Web server 127 and ends this process (step S104).

If the user ID and password are registered in the login management information 123 and the login access has succeeded (YES in step S103), the user's access to the community server 122 is granted permission by the controller 121. When a login request is input at the mail client 112, the mail client 112 issues a login request to the controller 121 of the server computer 12 via the mail server 128, and the same user authentication process as described above is done.

If the login access has succeeded, the community server 122 searches the user table 201 (FIG. 6) contained in the community management information 124 on the basis of the user ID designated via the controller 121 to acquire a user name of that user ID (step S105). The community server 122 searches the member table 204 (FIG. 9) using the acquired user name as a key to acquire the corresponding member ID and member type (step S106). After that, the community server 122 searches the community table 202 (FIG. 7) using the acquired member ID as a key to acquire community names of communities in which the user of interest participates, and their community types (step S107).

The community server 122 generates the relationship among the communities, members, and user described using FIG. 13 on the basis of the information acquired by the aforementioned process (step S108), and searches the user permitted access table 208 (FIG. 14) (step S109) to determine accesses that the login user can make (step S110). After that, the community server 122 returns a community list window that the user can access, an access window which contains only operation buttons available for each community, or the like as access window information to the Web browser 111 via the Web server 127 (step S111).

The Web browser 111 displays the access window information returned from the community server 122 on the window (step S112), and the user selects and executes operation on that displayed window (step S113). More specifically, the user selects a community to be accessed from the community list window that he or she can access to request the community server 122 to send the access window of that community, and to browse or post a message within his or her authority on the access window associated with the selected community.

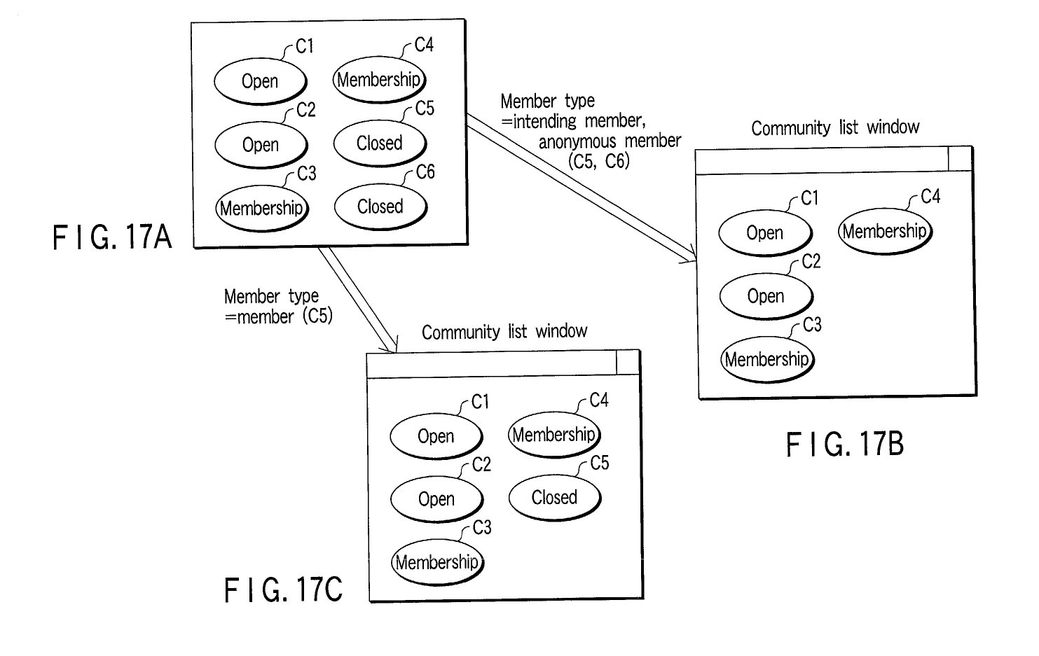

FIGS. 17A to 17C show an example of the community list window provided from the community server 122 to the user.

As shown in FIG. 17A, assume that open communities C1 and C2, membership communities C3 and C4, and closed communities C5 and C6 are present on this system. If the member type of the user of interest for closed communities C5 and C6 is neither “member” nor “temporary registered member”, but is “intending member” or “anonymous member”, closed communities C5 and C6 are not displayed on the community list window provided to that user, and other open communities C1 and C2 and membership communities C3 and C4 are displayed as a list of accessible communities, as shown in FIG. 17B. When the user selects a community on the community list, a window used to access the selected community is displayed.

If the member type of the user of interest for community C5 of closed communities C5 and C6 is “member”, closed community C5 is also displayed as a list of accessible community on the community list window provided to that user, as shown in FIG. 17C. When the member type of that user for closed community C5 is “temporary registered member”, that user is currently “temporarily registered in closed community C5, and link information to call a sign-up procedure window to that community C5 is displayed on the community list window.

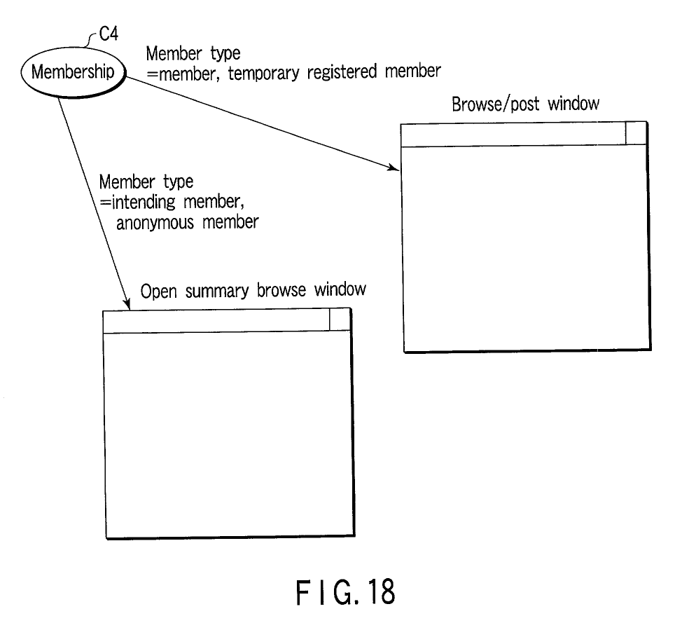

FIG. 18 shows an example wherein different access windows are displayed on the basis of the relationship between the community selected on the community list window and the member type of the user of interest with respect to that community. If the user selects membership community C4, and the member type of that user for membership community C4 is “member” or “temporary registered member”, an access window used to post or browse a message in that community C4 is displayed, as shown in FIG. 18. In this case, if the member type is “member”, a title list of all messages (including closed summary messages) present in community C4 is displayed on the window. However, if the member type is “temporary registered member”, titles associated with closed summary messages are not displayed, and a title list of only normal messages and open summary messages is displayed.

On the other hand, if the member type of the user of interest-for membership community C4 is neither “member” nor “temporary registered member” but is “intending member” or “anonymous member”, an access window used to browse only open summary messages is displayed.

In this manner, only access information that a given user can make is provided to that user. Hence, the user can make available access independently of the combination of the member type and community type, and access control according to the user's access authority can be implemented without any errors returned when the user makes a given access but that access is not accepted.

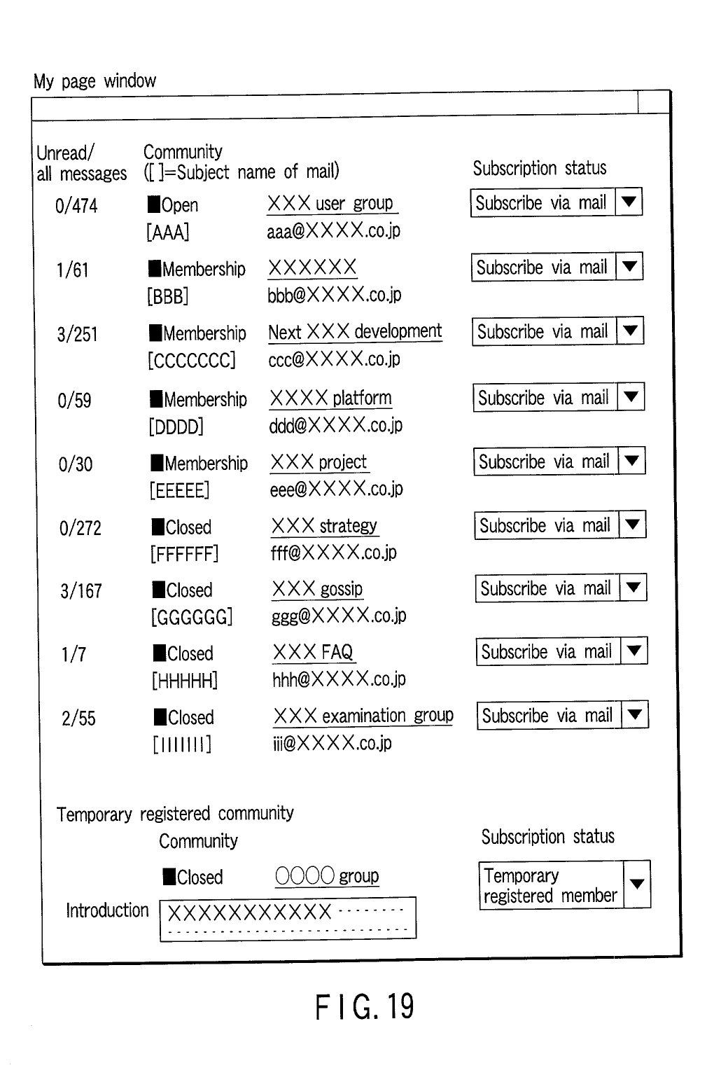

FIG. 19 shows an example of a community access/management window called my page, which is provided from the community server 122 to the user. This my page window is a kind of community list window. However, unlike in FIG. 17, only information that pertains to communities in which the user actually participates as “member”, and communities in which the user is temporarily registered as “temporary registered member” is displayed.

That is, the community type (open, membership, closed), community name (e.g., “XXX user group”, “next XXX development”, . . . ), the mail address of a community, and “subscription status” button used to display the current subscription type and to change a setup are displayed for each community with the member type “member”. Upon pressing the “subscription status” button, a pull-down list used to change the current subscription type is displayed, and the user can change the subscription type from “subscribe via mail” to “subscribe via Web” or vice versa. Also, for a community other than that in which the user himself or herself is an administrator, the user can “withdraw” from the community on the pull-down list.

If the current member type of a given community is “temporary registered member”, the community name (e.g., ◯◯◯ group”) and introduction of that community are displayed as information that pertains to the community in which the user is temporarily registered or has not signed up yet, and “temporary registered member” is displayed on the “subscription status” button. If the user presses the “subscription status” button, a “sign-up” button is displayed on the pull-down list, and the member type can be changed from “temporary registered member” to “member” by pressing the “sign-up” button.

<User Access Limiting Process #2>

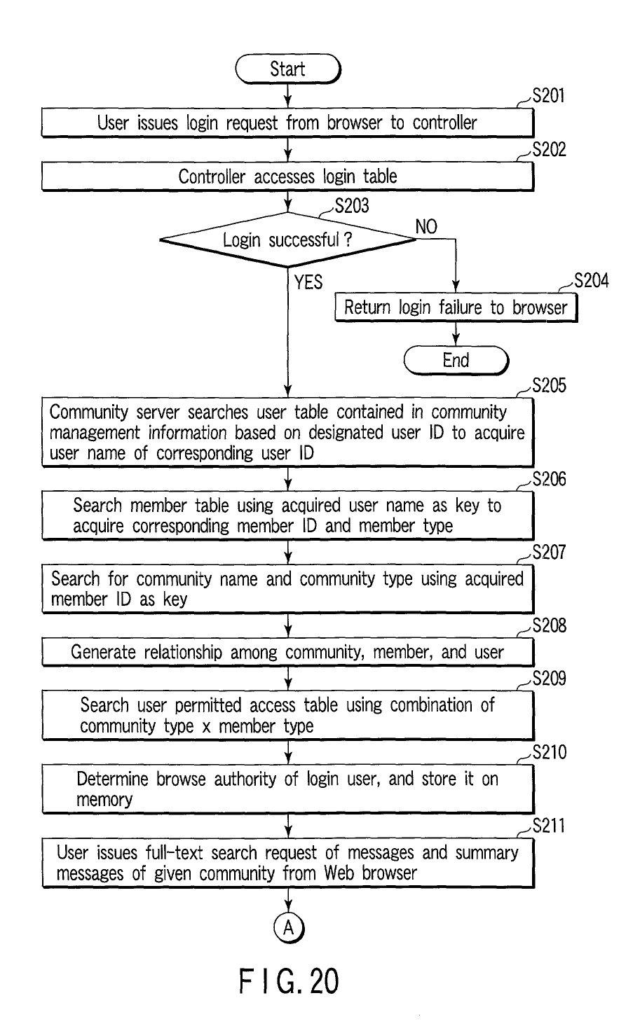

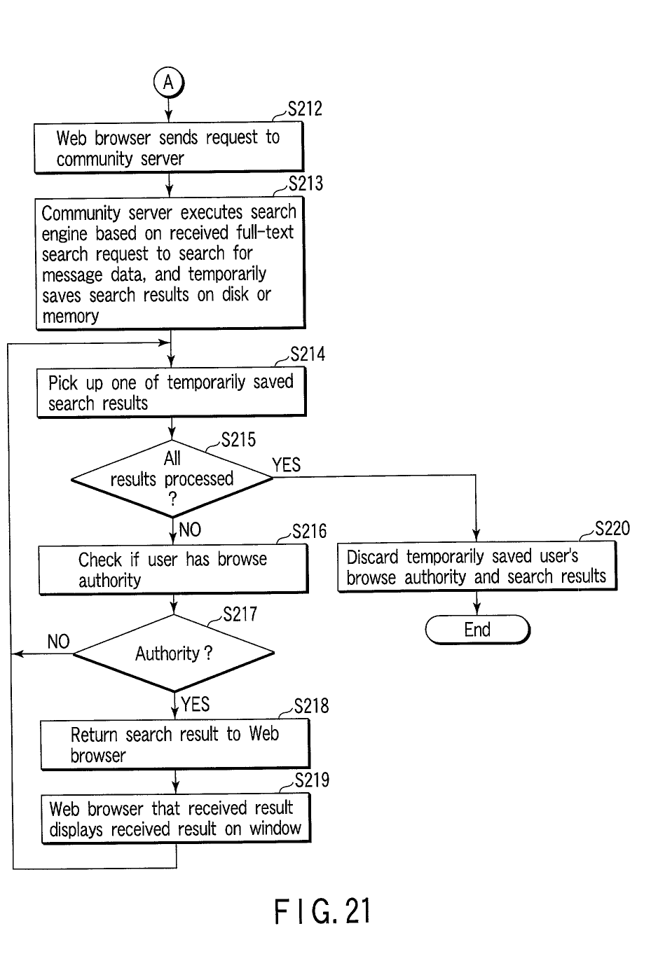

An operation upon a message search process as the second example of the user access limiting process will be explained below with reference to the flow charts in FIGS. 20 and 21.

The Web browser 111 issues a login request to the controller 121 of the server computer 12 via the Web server 127 in response to user's operation on the Web browser 111 (step S201). The controller 121 accesses the login management information 123 (step S202) to check if the user ID and password input from that user are registered, and makes user authentication (step S203) to determine if that login access is permitted.

If the user ID and password are not registered in the login management information 123 and the login access has failed (NO in step S203), the controller 121 returns a login failure to the Web browser 111 via the Web server 127 and ends this process (step S204)

If the user ID and password are registered in the login management information 123 and the login access has succeeded (YES in step S203), the user's access to the community server 122 is granted permission by the controller 121.

If the login access has succeeded, the community server 122 searches the user table 201 (FIG. 6) contained in the community management information 124 on the basis of the user ID designated via the controller 121 to acquire a user name of that user ID (step S205). The community server 122 searches the member table 204 (FIG. 9) using the acquired user name as a key to acquire the corresponding member ID and member type (step S206). After that, the community server 122 searches the community table 202 (FIG. 7) using the acquired member ID as a key to acquire community names of communities in which the user of interest participates, and their community types (step S207).

The community server 122 generates the relationship among the communities, members, and user described using FIG. 13 on the basis of the information acquired by the aforementioned process (step S208), searches the user permitted access table 208 (FIG. 14) using a combination of community type×member type (step S209) to determine the authority associated with message browsing available for the login user for each community, and stores the determined authority on a memory of the server computer 12 (step S210).

If the user issues a full-text search request of messages or summary messages by designating a specific community or all communities from the Web browser 111 (step S211), the Web browser 111 sends the search request to the community server 122 (step S212).

The community server 122 executes the search engine 130 based on the received full-text search request to search for message data which match the request, and temporarily saves all search results on a disk or memory of the server computer 12 (step S213). The community server 122 executes the following process to provide a search result list of only messages that the user can browse in the temporarily saved message search results.

That is, the community server 122 picks up one of temporarily saved message search results (step S214), and checks if it has processed all search results by detecting if the picked-up message search result has already been processed (step S215). If the message search result is not processed, the community server 122 checks if the user has the browse authority of the picked-up message (step S216). If the user has the browse authority (YES in step S217), the server 122 returns the search result to the Web browser 111 (step S218). This search result is displayed on the window by the Web browser 111 (step S219). On the other hand, if the user has no browse authority of that message (NO in step S217), the search result is not returned to the Web browser 111, and the flow returns to step S214 to execute the process for the next message search result.

In this manner, the process from step S214 is repeated until the process for all search result is complete, thereby providing a search result list of only messages (including summary messages) that the browse authority of the user can cover from those which match the search request to the client terminal 111 as the search request source. In this case, the search result that the browse authority of the user can cover is sent one by one. Alternatively, all search results that the browse authority of the user can cover may be sent together.

Upon completion of the process for all search results (YES in step S215), the process for discarding the temporarily saved user's browse authority and search results is executed to prepare for the next search request (step S220).

When the user selects a message from the search result list displayed on the window by the Web browser 111, he or she can acquire and browse text of that message from the community server 122. Hence, access control according to the user's access authority can be implemented without displaying any message, the browse request of which is denied, in a search result list upon actually browsing messages.

Note that all authorities are given to the site administrator, and browse limitations on search results depending on the authority level are not required. Also, the administrator of a given community has all authorities associated with that community.

As described above, according to the community-based collaborative knowledge system of this embodiment, since the community server 122 which manages posting and browsing of messages with respect to respective communities has a mechanism for limiting user access in accordance with the user's participation level for each community as a member, knowledge accumulation support can be achieved without failing participation will to communities, while maintaining desired security level.

Since all the functions of the community-based collaborative knowledge system of this embodiment are implemented by computer programs, these computer programs are stored in a computer-readable storage medium, and are installed in a normal computer, which can be connected to a computer network, via the storage medium, thus obtaining the same effects as in this embodiment.

The present invention is not limited to the aforementioned embodiment, and various modifications may be made without departing from the scope of the invention when it is practiced. Furthermore, the embodiment includes inventions of various stages, and various inventions can be extracted by appropriately combining a plurality of required constituent elements disclosed in this application. For example, even when some required constituent elements are deleted from all the required constituent elements disclosed in the embodiment, an arrangement from which those required constituent elements are deleted can be extracted as an invention if the effect of the present invention is obtained.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A community-based collaborative knowledge system which can be connected to a plurality of client terminals via a network, and supports knowledge accumulation by categorizing and accumulating messages posted from each client terminal to a virtual community, comprising:
access control means for making user authentication of a client terminal as an access request source so as to permit the client terminal to post a message; and
community processing means for managing a virtual community in which a plurality of client terminals can participate, and categorizing and accumulating messages posted, to the virtual community, from the client terminals, which are granted access permission by said access control means, for respective topics,
said community processing means including:
user access limiting means for managing a community type indicating an open level of each virtual community, and a member type indicating a participation attribute of a user to the virtual community, and determining user's access authority of each client terminal using a combination of the community type and member type for each virtual community as an access destination.

2. A system according to claim 1, wherein said user access limiting means determines an access that a client terminal as an access request source can make on the basis of the combination of the community type and member type, and provides a window which allows only the determined access to the client terminal as the access request source.

3. A system according to claim 1, wherein when the virtual community has a community type “membership” for only a group of authorized members, said user access limiting means permits a user whose member type for the virtual community is “member”, to post and browse messages, and inhibits a user whose member type for the virtual community is unauthorized “intending member” or “anonymous member”, from posting and browsing messages.

4. A system according to claim 1, wherein said community processing means further comprises means for managing summary messages which summarize messages accumulated in the virtual community for respective topics, and
when the virtual community has a community type “membership” for only a group of authorized members, said user access limiting means permits a user whose member type for the virtual community is “member”, to post and browse all messages including the summary messages, and permits a user whose member type for the virtual community is unauthorized “intending member” or “anonymous member”, to browse only summary messages having an open attribute of the summary messages in the virtual community.

5. A system according to claim 1, wherein the community type of each virtual community includes “open” that allows everyone to participate, “membership” for only a group of authorized members, and “closed” that is not open to the public other than authorized members,
the member type indicating the participation attribute of the user includes “member” who has been authorized to participate, “temporary registered member” who is temporarily registered as a member, “intending member” who has applied to participate but has not been authorized to participate yet, and “other”, and
said user access limiting means determines accesses that the client terminal as the access request source can make on the basis of combinations between the “open”, “membership”, and “closed” community types, and the “member”, “temporary registered member”, “intending member”, and “other” member types.

6. A system according to claim 1, further comprising search means for searching messages accumulated in virtual communities in response to a search request from the client terminal, and
wherein said user access limiting means provides a search result list consisting of message search results that browse authority of the client terminal as the search request source can cover of messages which match the search result on the basis of a combination of the community type of the virtual community which is to undergo search, and the member type of the client terminal as the search request source for the virtual community.

7. A user access limiting method in a community-based collaborative knowledge system which can be connected to a plurality of client terminals via a network, and supports knowledge accumulation by categorizing and accumulating messages posted from each client terminal to a virtual community, comprising:
the access control step of making user authentication of a client terminal as an access request source so as to permit the client terminal to post a message; and
the community processing step of managing a virtual community in which a plurality of client terminals can participate, and categorizing and accumulating messages posted, to the virtual community, from the client terminals, which are granted access permission in the access control step, for respective topics,
the community processing step including:
the user access limiting step of managing a community type indicating an open level of each virtual community, and a member type indicating a participation attribute of a user to the virtual community, and determining user's access authority of each client terminal using a combination of the community type and member type for each virtual community as an access destination.

8. A method according to claim 7, wherein the user access limiting step includes the step of determining an access that a client terminal as an access request source can make on the basis of the combination of the community type and member type, and providing a window which allows only the determined access to the client terminal as the access request source.

9. A method according to claim 7, wherein the user access limiting step includes the step of permitting a user whose member type for the virtual community is “member”, to post and browse messages, and inhibiting a user whose member type for the virtual community is unauthorized “intending member” or “anonymous member”, from posting and browsing messages, when the virtual community has a community type “membership” for only a group of authorized members.

10. A method according to claim 7, wherein messages accumulated in the virtual community include summary messages which summarize the messages for respective topics, and
the user access limiting step includes the step of permitting a user whose member type for the virtual community is “member”, to post and browse all messages including the summary messages, and permitting a user whose member type for the virtual community is unauthorized “intending member” or “anonymous member”, to browse only summary messages having an open attribute of the summary messages in the virtual community, when the virtual community has a community type “membership” for only a group of authorized members.

11. A method according to claim 7, wherein the community type of each virtual community includes “open” that allows everyone to participate, “membership” for only a group of authorized members, and “closed” that is not open to the public other than authorized members,
the member type indicating the participation attribute of the user includes “member” who has been authorized to participate, “temporary registered member” who is temporarily registered as a member, “intending member” who has applied to participate but has not been authorized to participate yet, and “other”, and
the user access limiting step includes the step of determining accesses that the client terminal as the access request source can make on the basis of combinations between the “open”, “membership”, and “closed” community types, and the “member”, “temporary registered member”, “intending member”, and “other” member types.

12. A method according to claim 7, further comprising the search step of searching messages accumulated in virtual communities in response to a search request from the client terminal, and
wherein the user access limiting step includes the step of providing a search result list, consisting of message search results that browse authority of the client terminal as the search request source can cover of messages which match the search result, on the basis of a combination of the community type of the virtual community which is to undergo search, and the member type of the client terminal as the search request source for the virtual community.

13. A program used in a community-based collaborative knowledge system which can be connected to a plurality of client terminals via a network, and supports knowledge accumulation by categorizing and accumulating messages posted from each client terminal to a virtual community, said program making a computer execute:
the access control step of making user authentication of a client terminal as an access request source so as to permit the client terminal to post a message; and
the community processing step of managing a virtual community in which a plurality of client terminals can participate, and categorizing and accumulating messages posted, to the virtual community, from the client terminals, which are granted access permission in the access control step, for respective topics,
the community processing step including:
the user access limiting step of managing a community type indicating an open level of each virtual community, and a member type indicating a participation attribute of a user to the virtual community, and determining user's access authority of each client terminal using a combination of the community type and member type for each virtual community as an access destination.

14. A program according to claim 13, wherein the user access limiting step includes the step of determining an access that a client terminal as an access request source can make on the basis of the combination of the community type and member type, and providing a window which allows only the determined access to the client terminal as the access request source.

15. A program according to claim 13, wherein the user access limiting step includes the step of permitting a user whose member type for the virtual community is “member”, to post and browse messages, and inhibiting a user whose member type for the virtual community is unauthorized “intending member” or “anonymous member”, from posting and browsing messages, when the virtual community has a community type “membership” for only a group of authorized members.

16. A program according to claim 13, wherein messages accumulated in the virtual community include summary messages which summarize the messages for respective topics, and
the user access limiting step includes the step of permitting a user whose member type for the virtual community is “member”, to post and browse all messages including the summary messages, and permitting a user whose member type for the virtual community is unauthorized “intending member” or “anonymous member”, to browse only summary messages having an open attribute of the summary messages in the virtual community, when the virtual community has a community type “membership” for only a group of authorized members.

17. A program according to claim 13, wherein the community type of each virtual community includes “open” that allows everyone to participate, “membership” for only a group of authorized members, and “closed” that is not open to the public other than authorized members,
the member type indicating the participation attribute of the user includes “member” who has been authorized to participate, “temporary registered member” who is temporarily registered as a member, “intending member” who has applied to participate but has not been authorized to participate yet, and “other”, and
the user access limiting step includes the step of determining accesses that the client terminal as the access request source can make on the basis of combinations between the “open”, “membership”, and “closed” community types, and the “member”, “temporary registered member”, “intending member”, and “other” member types.

18. A program according to claim 13, further comprising the search step of searching messages accumulated in virtual communities in response to a search request from the client terminal, and
wherein the user access limiting step includes the step of providing a search result list, consisting of message search results that browse authority of the client terminal as the search request source can cover of messages which match the search result, on the basis of a combination of the community type of the virtual community which is to undergo search, and the member type of the client terminal as the search request source for the virtual community.
